(19) United States
(12) Patent Application Publication
(10) Pub. No.: US 2006/0008784 A1
(43) Pub. Date: Jan. 12, 2006

(54) Leadership training method

(76) Inventor: Don Schmincke, Towson, MD (US)

Correspondence Address: LARRY J. GUFFEY, WORLD TRADE CENER - SUITE 1800, 401 EAST PRATT STREET, BALTIMORE, MD, 21202, US

(21) Appl. No.: 10/888,650

(22) Filed: Jul. 9, 2004

(51) Int. Cl. G09B 19/00

(52) U.S. Cl. 434/236

(57) ABSTRACT

The present invention is a method for teaching leadership skills to a designated leader of an organization. It includes the steps of teaching that: (a) a barrier to achieving desired organizational results comes from the dysfunctional behavior exhibited by the ones that the leader is trying to lead, (b) such dysfunctional behavior is likely driven by one's ego-driven, dysfunctional beliefs, (c) to remedy dysfunctional behavior, a leader must alter the ego-driven, dysfunctional beliefs which drive the behavior, and (d) to mitigate one's ego-driven, dysfunctional behavior, one may use any or all of the following techniques: (1) the use of despair or hopelessness to create an emptiness or void within which one exhibiting dysfunctional behavior can discover the courage to persevere and undergo the task of forsaking one's old beliefs and formulating new beliefs that allow one to adopt an authentic commitment to achieving desired organizational results, (2) the use of a compelling saga or passionate story in which one may believe and use to fill the voids in one's organizational life, (3) the creation of a feeling of shame in one exhibiting dysfunctional behavior as a means to promote the demise of one's ego-driven dysfunctional behavior, and (4) the creation of aligned beliefs within an organization to change the experiential environment of an organization.

### BACKGROUND OF THE INVENTION

1. Field of the Invention

The present invention relates to educational methods and business practices. More particularly, this invention relates to a system and method for improving one's leadership skills.

2. Description of the Related Art

Each year billions of dollars are spent on various leadership training and development efforts. These costs are incurred for the publication of a wide assortment of instructional materials (e.g., books, periodicals, videos, CD's, cassette tapes) and instructional programs (e.g., management training sessions, workshops and retreats).

Prior leadership training programs have offered a wide variety of strategies for increasing a leader's effectiveness. Many of these strategies have encouraged leaders to focus on improving what are referred to as the “content” (e.g., strategic and operational plans, business goals and objectives, measure and structures) and “process” (e.g., how things are organized and accomplished, how control of tasks and people are managed, how employees are trained and directed, how changes and improvements are made) aspects or dimensions of their organizations. See FIG. 1.

Meanwhile, concerns about any dysfunctional and/or non-productive behavior being exhibited by employees have typically been addressed by introducing management and employee training and team-building programs. See FIG. 2.

However, the positive results achieved with these various training efforts appear to be practically negligible. Industry experience indicates that leadership training has not only failed to produce positive results in the workplace, it has created an industry wide culture of cynicism and frustration and has led, in the U.S., to the most popular management revolt ever seen—the 1989 introduction of the very popular, Dilbert comic strip which often portrays organizational management as incompetent, bumbling, stupid, selfish and/or shallow. If leadership was working effectively, so many people wouldn't find Dilbert to be funny and chose to wallpaper their cubicle walls with these comic strips.

Despite their inability to show appreciable benefits in the workplace, over thirty thousand, different business books are published every year. Eager managers continue to buy them in the hope that the next best-seller will solve their organization's leadership issues.

The failure of prior leadership development programs is evident from the academic research and industry reports of a growing percentage of dysfunctional work behaviors and attitudes towards management: back-biting, blaming others, finger-pointing, accountability avoidance, sabotaging the efforts of co-workers, cynicism, frustration, resistance to change, despair, anger, passivity, and apathy. As much as 30%-80% of some organization's manpower efforts are estimated to be directed towards these destructive behaviors.

Even those companies that have at one time or another been identified as displaying exemplary leadership seem not to be able to continue with such leadership. Companies like IBM, Sears, Enron, and AOL/Time-Warner, that have made the top-ten managed companies list of management gurus like Tom Peters, seem to, with continuing revelations of significant corporate problems, rotate off such lists as fast as they rotate onto them.

Despite many prior efforts to develop and introduce better management training programs, there still exists a significant need for such programs.

3. Objects and Advantages

There has been summarized above, rather broadly, the prior art that is related to the present invention in order that the context of the present invention may be better understood and appreciated. In this regard, it is instructive to also consider the objects and advantages of the present invention.

An object of the present invention is to provide improved management training methods and systems.

Another object of the present invention is to provide managers with the tools and methods that will enable them to improve their capacity to lead in the variety of management dimensions, including: implementing change, aligning behaviors, reducing turnover, increasing sales, decreasing costs, improving ethical behavior, enhancing culture and improving product quality.

Yet another object is to teach a method whereby managers may create increased accountability and commitment in the groups they lead.

Another object is to reveal what is often the primal driver that controls an employee's actions within an organization.

An object of the present invention is to show how properly utilizing this primal driver can result in greater organizational efficiency and productivity.

Another object is to show how dysfunctional behavior with an organization can be minimized.

Still another object is to show how effective leadership can increase a group's success in achieving organizational goals.

An object of the present invention is to show how effective leadership can increase a group's sense of commitment and accountability towards achieving organizational goals.

Other objects and advantages of the present invention will become readily apparent as the invention is better understood by reference to the accompanying drawings and the detailed description that follows.

### SUMMARY OF THE INVENTION

The present invention is generally directed to satisfying the needs set forth above and overcoming the limitations and problems identified with prior leadership training programs.

In accordance with one preferred embodiment, the present invention takes the form of a method teaching leadership skills. It includes the steps of teaching that: (a) results are produced from behavior, not content and process, (b) beliefs drive behavior, (c) a barrier to achieving desired organizational results comes from the dysfunctional behavior exhibited by the ones that the leader is trying to lead, (d) such dysfunctional behavior is likely driven by one's ego-driven, dysfunctional beliefs, (e) to remedy dysfunctional behavior, a leader must alter the ego-driven, dysfunctional beliefs which drive the behavior, and (f) to mitigate one's ego-driven, dysfunctional behavior, one may use any or all of the following techniques: (1) the use of despair or hopelessness to create an emptiness or void within which one exhibiting dysfunctional behavior can discover the courage to persevere and undergo the task of forsaking one's old beliefs and formulating new beliefs that allow one to adopt an authentic commitment to achieving desired organizational results, (2) the use of a compelling saga or passionate story in which one may believe and use to fill the voids in one's organizational life, (3) the creation of a feeling of shame in one exhibiting dysfunctional behavior as a means to promote the demise of one's ego-driven dysfunctional behavior, and (4) the creation of aligned beliefs within an organization to change the experiential environment of an organization, and (5) the exposure of the myth that employees follow leaders; what employees actually follow is the story that the leaders represent.

Thus, there has been summarized above, rather broadly, the present invention in order that the detailed description that follows may be better understood and appreciated. There are, of course, additional features of the invention that will be described hereinafter and which will form the subject matter of any eventual claims to this invention.

### BRIEF DESCRIPTION OF THE DRAWINGS

FIG. 1 illustrates the basic components of many prior art methods of teaching leadership.

FIG. 2 illustrates the basic components of many prior art methods for correcting dysfunctional behavior in an organization.

FIG. 3 shows the basic components of a preferred embodiment of the present invention.

FIG. 4 illustrates the model of how beliefs drive behavior, and that behavior drives results.

FIG. 5 illustrates how dysfunctional behavior slows and impedes an organization's achievement of results, and can be corrected by the use ego subjugation techniques.

FIG. 6 illustrates how ego-driven beliefs influence one's perceptions of an event.

FIG. 7 shows the basic components of another preferred embodiment of the present invention used for correcting dysfunctional behavior.

FIG. 8 illustrates how the return on one's efforts at leading a group to adopt new beliefs increases at different rates during the various stages of this process.

FIG. 9 illustrates the characteristics that an individual or a group should be expected to exhibit during the various stages of the process of subordinating old beliefs so that new beliefs may be adopted.

FIG. 10 illustrates how management teams transition to new beliefs or higher level of performance along a set of such belief curves (i.e., country club, shared destiny, armed & dangerous).

FIG. 11 illustrates the to-be-expected characteristics that are often evident in a group of organizational leaders who are trying to lead their organization as it progresses along the path towards the adoption of new beliefs.

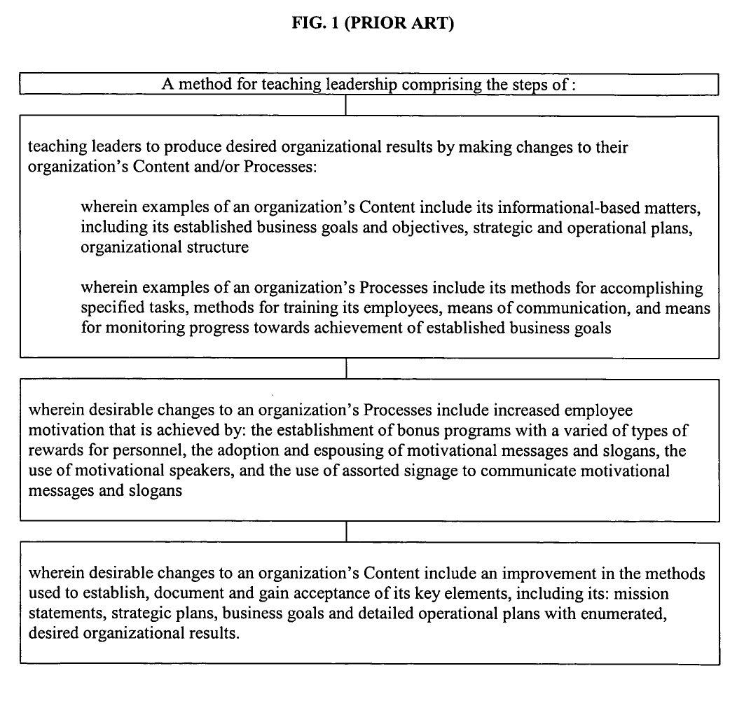

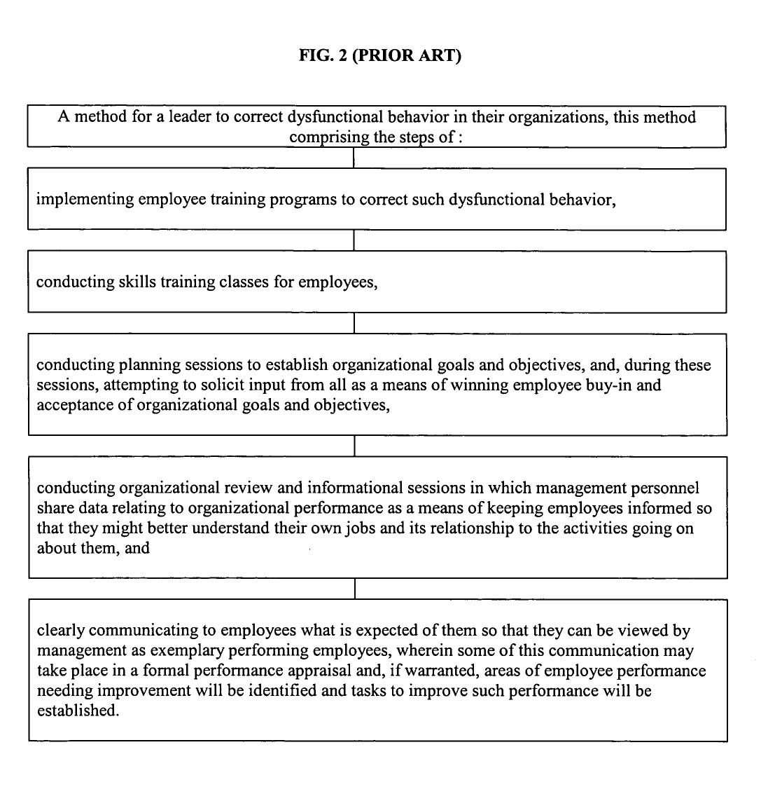

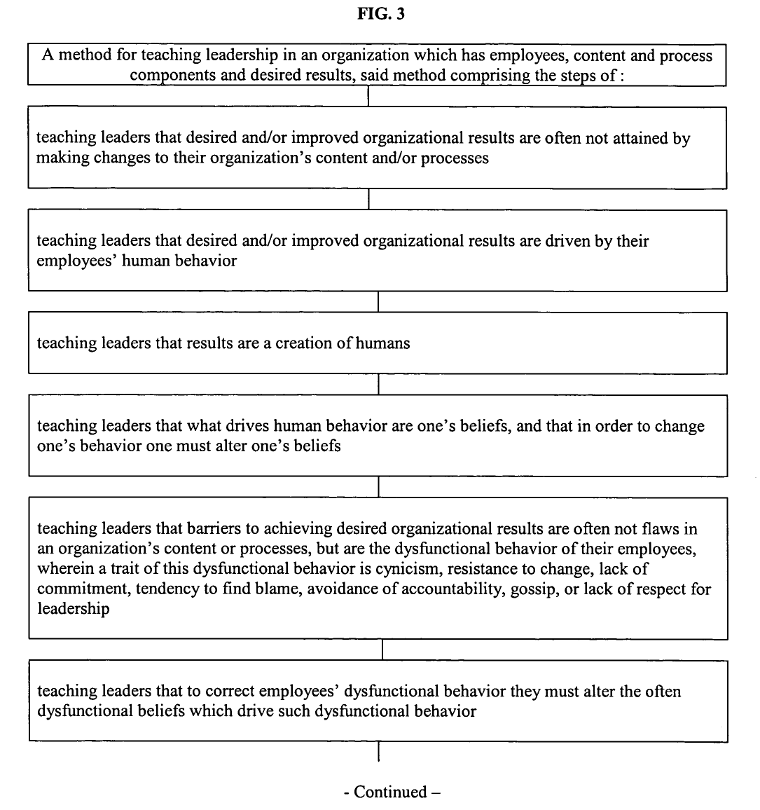

### DESCRIPTION OF THE PREFERRED EMBODIMENT

For purposes of explanation and not limitation, specific details are set forth below in order to provide a thorough understanding of the present invention. However, it will be apparent to one skilled in the art that the present invention may be practiced in other embodiments that depart from these specific details.

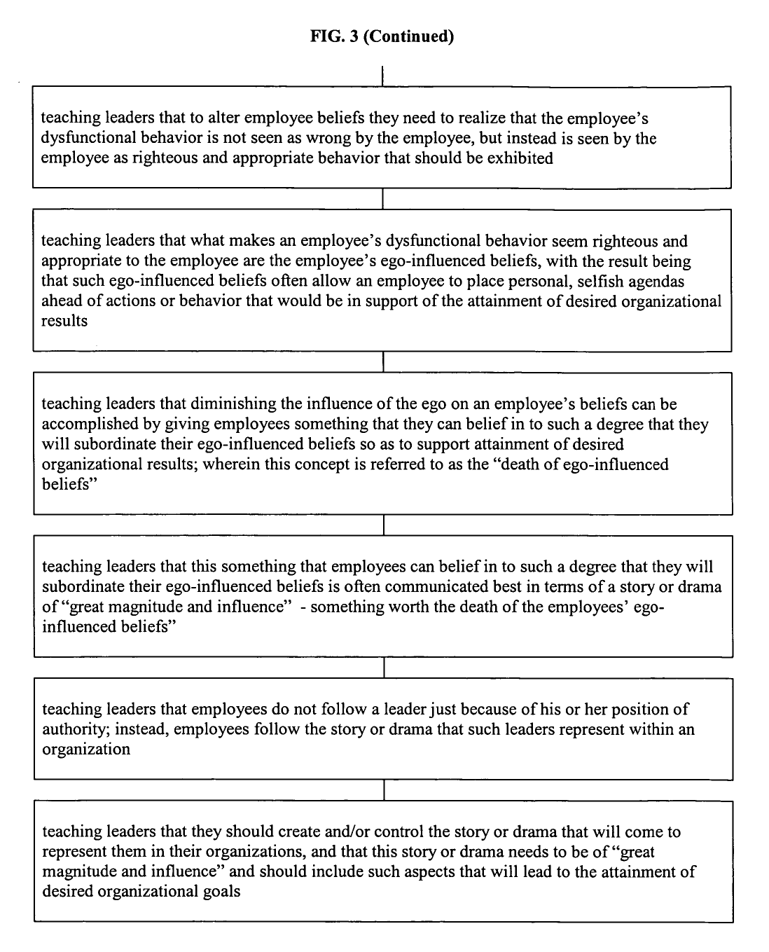

Referring now to the drawings wherein are shown preferred embodiments and wherein like reference numerals designate like elements throughout, there is shown in FIG. 3 one embodiment of the present invention which takes the form of a method for teaching organizational leadership. This method involves teaching leaders many new ideas regarding leadership effectiveness.

These new ideas include, teaching leaders that: (a) desired and/or improved organizational results are often not attained by making changes to their organization's content and/or processes, as in previous art, but by altering the behavior of their employees, (b) beliefs drive behavior, (c) desired results derive from the efforts of leaders, they wouldn't come about without effective leadership, (d) one of the greatest barriers to achieving desired and/or improved organizational results often comes from employees' dysfunctional behavior, (e) such behavior is often driven by employees' beliefs, and not by flaws in their organization's content and/or processes, (f) ego-driven beliefs of employees drive dysfunctional behavior, including: cynicism, resistance to change, lack of commitment, tendency to find blame, avoidance of accountability, gossip, and lack of respect for leadership, (g) to correct employees' dysfunctional behavior, leaders must not rely on content and process changes, but must instead alter the beliefs of their employees which are driving such behavior, (h) to alter these beliefs, leaders must realize that the dysfunctional behavior of their employees is often not seen as wrong by them; but, instead is seen as righteous and appropriate behavior that should be exhibited, (i) what makes this dysfunctional behavior seem to be righteous and appropriate is often the influence of the employee's ego, which is the source of their dysfunctional beliefs, with such beliefs often allowing the employee to place personal, selfish agendas ahead of actions or behavior that would be in support of the attainment of desired organizational results, and (j) diminishing the influence of the ego on an employee's beliefs can be accomplished by giving employees something that they can belief in to such a degree that they will subordinate their ego-influenced beliefs so as to support attainment of desired organizational results; wherein this concept is referred to as the “death of ego-influenced beliefs,” and (k) having a compelling drama or passionate story drives performance by giving employees something to believe in and die for (in the sense of subordinating one's ego-influenced beliefs.

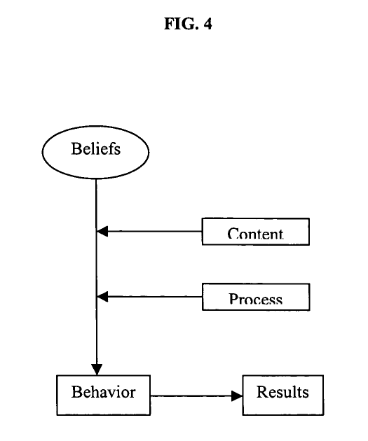

FIG. 4 shows one of these new ideas or pieces of knowledge that are associated with the present invention. In this figure, it is shown that results are achieved not by the direct application of an organization's content and process aspects. Instead, results are seen to be a product of the behavior of those that comprise the organization, and what drives such personnel are their beliefs. If an organization wishes to alter its results, it must alter its beliefs. The frequent lack of this alteration of beliefs is the reason for the high failure rate of organizational change programs. Content and process are tools, but not drivers; as any parent knows when they finally realize that information does not transform their children's lives, but experience does.

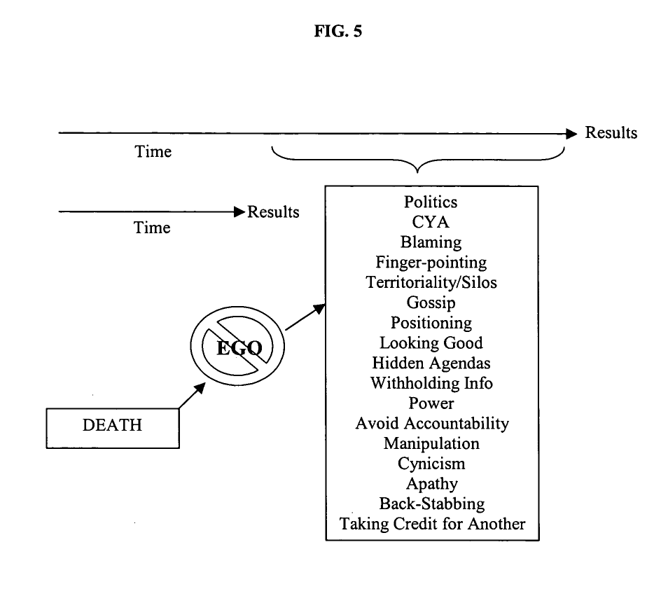

FIG. 5 shows another of these new ideas or pieces of knowledge that are associated with the present invention. It emphasizes that the speed with which an organization can accomplish a given task is greatly impeded by the dysfunctional behavior of its personnel. The figure indicates that the reason an organization slows down is not necessarily its flawed processes or content, as prior leadership training methods have suggested.

Examples of such dysfunctional behavior include: excessively politically dictated actions, territoriality, cover your ass behavior, blaming others, accountability avoidance, actions directed at looking good for the boss at the expense of others, taking credit for the ideas of others, back-stabbing, and finger-pointing.

I believe that I have found that: (1) much of this dysfunctional behavior is directly attributable to ego-influenced beliefs, (2) such dysfunctional behavior is not seen to be wrong or improper behavior by those who exhibit it; instead, it is often seen by those who exhibit it as being even righteous and appropriate behavior which should be exhibited, and (3) the most effective way to remedy such ego-influenced or driven beliefs is through a process that I call the “death of ego-driven beliefs” (i.e., the adoption of new beliefs that are more powerful than those generated by the ego, which results in one being able to subjugate the ego's agenda to a higher cause—such as the attainment of desired organizational goals). Various ways and methods to perform this process are described below.

I have found that creating a feeling of despair or hopelessness in followers who are exhibiting dysfunctional behavior, as a means to formulate an emptiness or void within these individuals, is an effective means of promoting the “death of ego-driven beliefs.” It has been my experience that a leader can use a follower's feeing of emptiness or void to help the follower to discover the courage to persevere and undergo the sometimes painful task of forsaking their old beliefs so as to formulate new beliefs that will no longer support their dysfunctional behavior, thereby allowing these individuals to adopt an authentic commitment to achieving desired organizational results.

Additionally, I have found that one possible way to create such feelings of emptiness is for a leader to confront ego-driven, dysfunctional followers with the organization's conclusion that the organization will fail to meet its organizational goals, with dire consequences for all group members, as a result of the follower's ego-driven, dysfunctional behavior.

Within groups, I have also found that “shame” within a dysfunctional follower can be used as a means to promote the demise of his/her ego-driven dysfunctional behavior. Shame can be used to drive people to be brave enough to do the scariest thing in eliminating dysfunction—tell the truth to each other.

Note that this approach is quite different from the prior art's focus on developing self esteem in group members, and the use of touchy-feely team building exercises. These techniques have a flaw as can be seen by the fact that criminals can often be found who have self-esteem and pride, yet they still display dysfunctional and even criminal behavior.

Organizations having people who tell the truth to each other outperform organizations where people lie to each other. However, the task of having people start to tell the truth to each other can be painful.

Anthropological studies reveal that ancient leaders had an alternative and more interesting approach to fostering a desired trait within their groups. They found that less brave individuals would go into battle with the naturally brave because they were too ashamed to turn and run in front of their peers. We can apply this in groups to foster truth telling. The way this process can be implemented in a group is as follows:
1) Share an ancient story about this phenomena. This allows a stealthy approach under the ego's radar with the result that individuals are not threaten at this point.
2) The group is then challenged to be brave enough to say to each other what they have been thinking and not saying.
3) If this is not successful, then the group is challenged on its bravery or lack thereof.
4) If this does not produce enough shame, then the members of the group are reminded that they know who they are because they said something about the team or situation to someone else in this room outside this meeting—someone is now looking at them wondering if they are a coward.

This procedure will usually produce the desired shame response and drive a bravery action toward truth telling within the group.

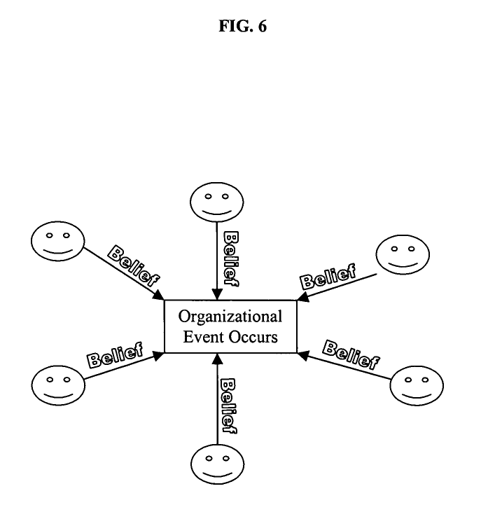

FIG. 6 emphasizes another of the ideas or pieces of knowledge that proved to be helpful to me in formulating the present invention. It emphasizes that upon the occurrence of an event, those who witness it will often form quite different perceptions of what the event was. These perceptions are then used by the various witnesses in formulating their beliefs about the world around them. Because their perceptions are different and can be very ego dependent, it often happens that their beliefs will also be different. The process of formulating beliefs is seen to be, at least in part, experientially based and possibly ego biased.

Since it seems to be almost instinctive or human nature for those with similar beliefs to band together, sometimes to the detriment of those minorities with dissimilar beliefs who may become victims of the majority, it is important that a leader focuses on belief-alignment and try to formulate and create shared group experiences as a way to foster common beliefs and desired behaviors. Some means of doing this include the use by a leader of: (a) a compelling saga or passionate story in which the followers may believe and use to fill some of the voids that might exist in their organizational lives, and (b) symbols and rituals to align the beliefs of an organization.

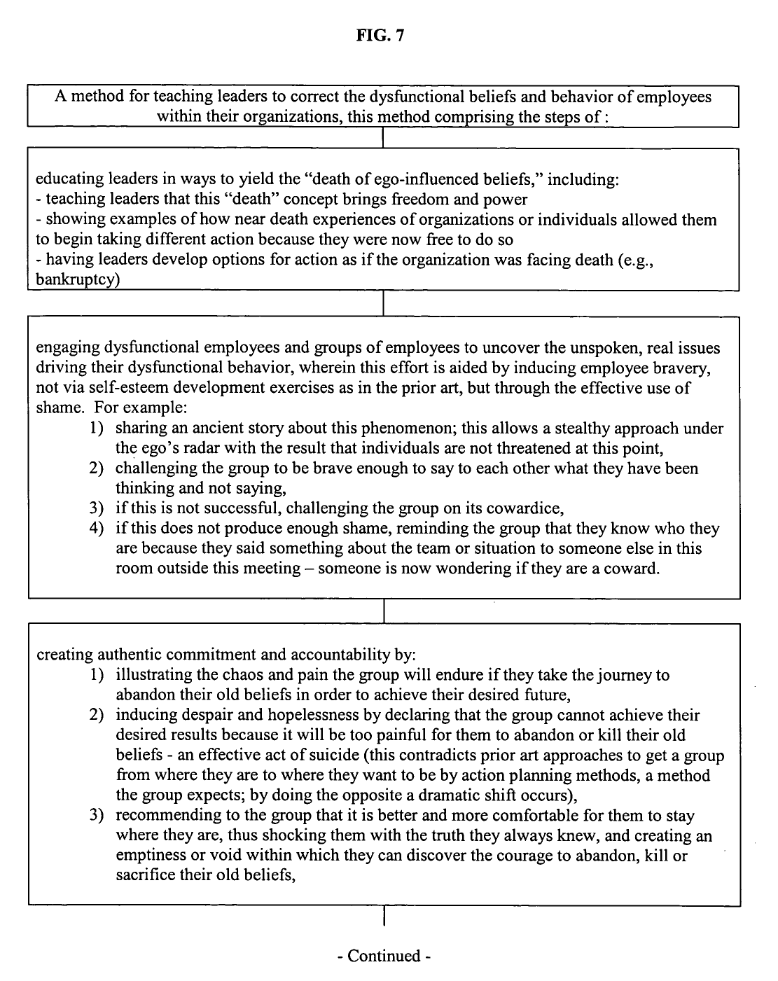

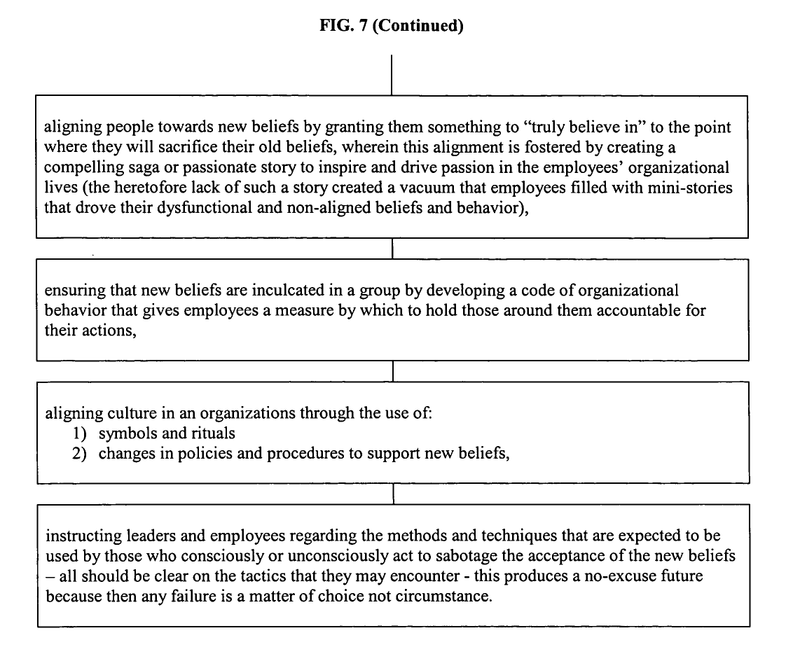

As represented in FIG. 7, another embodiment of the present invention takes the form of a method to correct dysfunctional beliefs and behavior in organizations. This includes what I believe to be the most effective way to remedy dysfunctional beliefs, and their consequent dysfunctional behavior. It consists of various ways and methods including:
(a) educating leaders in ways to yield the “death of ego-influenced beliefs,” including: (1) showing examples of how near death experiences of organizations or individuals allowed them to begin taking different action because they were now free to do so, (2) having leaders develop options for action as if the organization was facing death (e.g., bankruptcy), and (3) teaching how a compelling and inspiring saga can allow one to subjugate their ego to a higher cause;
(b) engaging dysfunctional employees and groups of employees to uncover the unspoken, real issues driving their dysfunctional behavior, wherein this effort is aided by inducing employee bravery, not via self-esteem development exercises as in the prior art, but through the effective use of shame. This involves driving people to do the scariest thing of all in eliminating dysfunction—tell the truth to each other. Note that this approach is quite different from prior art consulting and training methods which fail to access such passions when they focus on content applications like “mission or vision statements.” Experience has shown that the typical rank-and-file followers are not committed to such statements and generally will ignore, criticize, or generally be cynical about such leadership efforts. This failure of the prior art is so profound that a “Dilbert” website actually has a mission creation application that one can use to invent a company mission statement. Ways to accomplish this “uncovering the unspoken, real issues” include: (1) sharing an ancient story about this phenomenon; this allows a stealthy approach under the ego's radar with the result that individuals are not threatened at this point, (2) challenging the group to be brave enough to say to each other what they have been thinking and not saying, (3) if this is not successful, challenging the group on its cowardice, (4) if this does not produce enough shame, reminding the group that they know who they are because they said something about the team or situation to someone else in this room outside this meeting—someone is now wondering if they are a coward;
(c) creating authentic commitment and accountability by: (1) illustrating the chaos and pain the group will endure if they take the journey to abandon their old beliefs in order to achieve their desired future (this contradicts prior art approaches to motivate groups by making it easier and enjoyable and fun to change), (2) inducing despair and hopelessness by declaring that the group cannot achieve their desired results because it will be too painful for them to abandon or kill their old beliefs—an effective act of suicide (this contradicts prior art approaches to get a group from where they are to where they want to be by action planning methods, a method the group expects; by doing the opposite a dramatic shift occurs), and (3) recommending to the group that it is better and more comfortable for them to stay where they are, thus shocking them with the truth they always knew, and creating an emptiness or void within which they can discover the courage to abandon, kill or sacrifice their old beliefs (this contradicts prior art approaches to encouraging a group to move ahead with a variety of motivational methods);
(d) aligning people towards new beliefs by granting them something to “truly believe in” to the point where they will sacrifice their old beliefs, wherein this alignment is fostered by creating a compelling saga or passionate story to inspire and drive passion in the employees' organizational lives (the heretofore lack of such a story created a vacuum that employees filled with mini-stories that drove their dysfunctional and non-aligned beliefs and behavior). The present invention uses the compelling saga to drive beliefs. These sagas are produced through two steps: (1) Developing the competitive strategy of the organization—identify the marketplace battlefield and the competitors? With these elements defined, then it is possible to define “winning.” Then, and only then, should a mission statement be developed; and (2) Creating a “story” around this competitive strategy. This is a tough journey for most leaders because story-telling is not a talent for which leaders are usually known. But, it is exactly the “story” for which followers have passion and follow their leaders. Even with this evidence of the power of compelling sagas, management gurus still have organizations implementing content level missions that no one really cares about. You see this widespread in organizations that have their mission statements publicly displayed, but whose employees will not die for it (i.e., subjugate their ego-driven agenda to the higher cause). Yet such leaders still feel they have done their job by producing a mission statement regardless of its failed impact. The seduction of content and process solutions of the previous art of leadership blinds managers to the more potent art of managing employees' beliefs. Strong, cooperative leadership is needed to implement such compelling sagas into an organization. Yet many organizations lack such leadership. This failing has often been addressed in the prior art by exercises in team-building, communications training, etc. The reality is that this lack of leadership is not due to lack of skills, but from the failure to address employees ego-driven beliefs which are driving their dysfunctional behaviors;
(e) ensuring that new beliefs are inculcated in a group by developing a code of honor and organizational behavior that gives employees a measure by which to hold those around them accountable for their actions. This approach is seen to be preferable to the prior art's use of “Values Statements,” because these codes are to be stated in behavioral terms, and behavior is more difficult to hide in a group than one's values. For instance, the value of “respect” can be stated in an organization's “Value Statements, but a code gives it meaning by stating what respect looks like, what happens when it is violated, and what to do when someone tells you are the violator, etc.;
(f) aligning culture in an organizations through the use of symbols and rituals and changes in policies and procedures to support new beliefs. Symbols are those “things” about which people have special beliefs. These things have “cultural meaning.” For example: (1) A bank realizes that it needs to transform its culture. It sets about determining what symbols exist within its culture that honor or support the old culture. One symbol of the old culture is found to be the use of assigned parking spaces. Elimination of these assigned spaces is seen to have an immediate positive impact on the organization's culture. (2) A retail clothing chain serving the teen market takes their top sales-people to Miami for a conference as a symbolic reward for performance. After the event, they discover that it wasn't the money spent on the transportation, food and accommodations that was the most valued reward; it was the initial order of personalized business cards they were given to the top-performers. To the seventeen year-old salesperson, their first business card was a more powerful symbol than an expensive trip. (3) Other examples include where one's desk is positioned in the office layout, whether they have support staff assigned to them, what kind of company car they drive, and other “things” to which people assign special meaning. A problem with prior leadership training programs, and their preoccupation with content and process, is that they miss the power of belief drivers like symbols. The concept of belief drivers is not taught in business schools and seldom, if ever, mentioned in the technical literature, but chief executive officers (CEOs) occasionally have the importance of such symbols brought to their attention. For example, one CEO is reported to have found a sticky note on a terminal of an employee with the words “Good Job” written in her handwriting. She realized that she had given the note to the employee six months earlier for a report the employee had prepared—it's still hanging on the computer terminal. Another CEO eventually comes to realize that a contributing cause of the recently poor production from their flag-ship plant in Mexico was the firing of the plant's uniform vendor as the workers were instead given a stipend instead to buy their own work clothes. This made sense in the U.S., but in the community where the plant was located, one's status was often due to one having landed a job in the nearby American company. The workers' uniforms were like a symbol in that identified those who had this type of status. The workers' loss of this readily identifiable status led to morale and productivity problems. When the uniforms were brought back, plant productivity returned to its former high levels. Napoleon may have said it best, when he exclaimed how amazing it was what a man would do for a piece of ribbon. Some humans will even risk death for their symbols; and
(g) instructing leaders and employees regarding the methods and techniques that are expected to be used by those who consciously or unconsciously act to sabotage the acceptance of the new beliefs—all should be clear on the tactics that they may encounter—this produces a no-excuse future because then any failure is a matter of choice not circumstance.

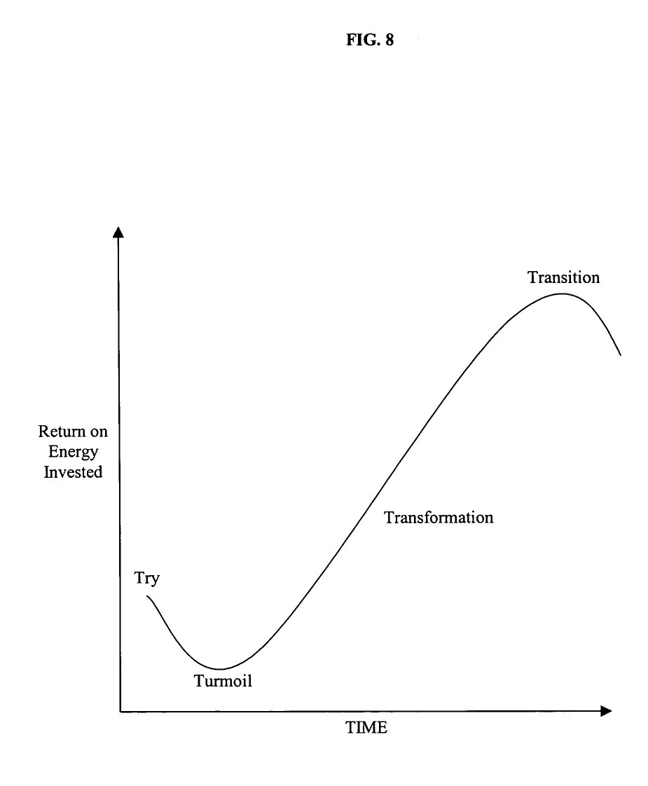

In endeavoring to implement the teachings of the present invention, I have found that the progress towards the adoption of new beliefs to replace the old, ego-driven beliefs is seldom steady. In fact, it often happens that one's initial efforts seem to result in little progress and may even appear to be causing new problems by seemingly throwing an organization into turmoil. However, if one preserves, the return on one's efforts steadily increases until eventually a full transition to the adoption of new beliefs is completed. This phenomena is illustrated in FIG. 8 which I refer to as a “Belief Curve” and which shows the rate of return on one's efforts at various stages (e.g., try, turmoil, transformation and transition) throughout this process.

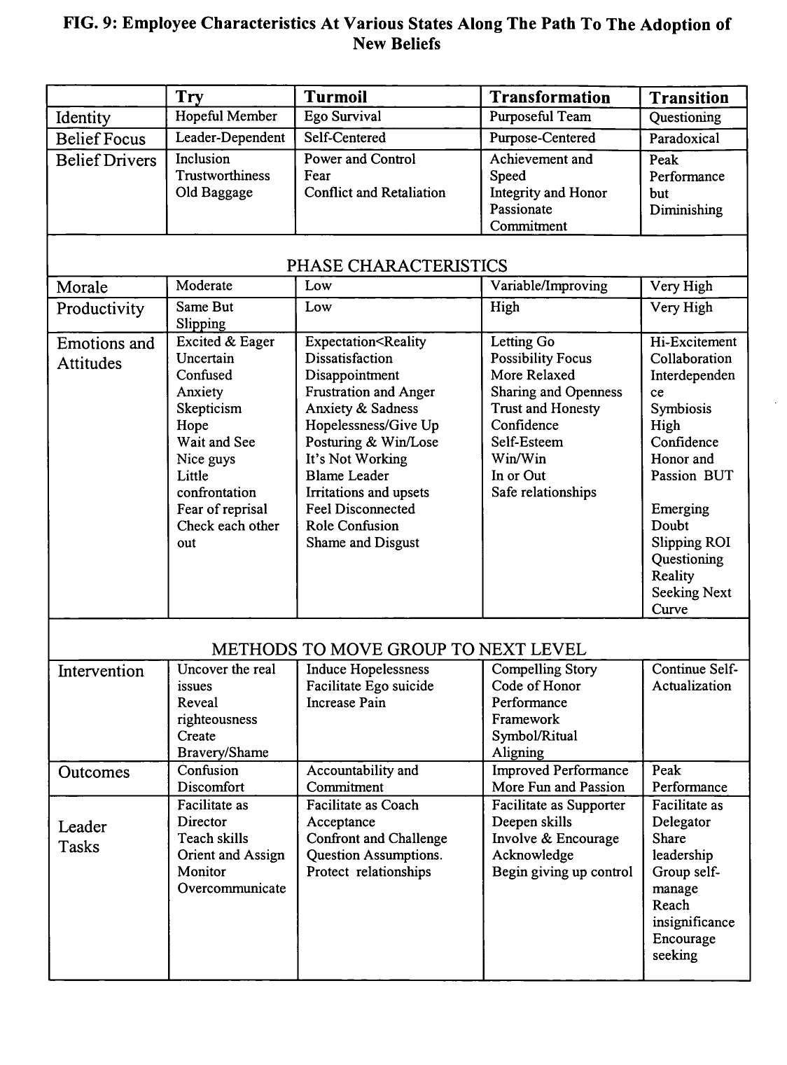

I have also found the exhibited characteristics of groups of employees at each of these various stages during the process to be surprisingly similar. Some of these characteristics are shown in FIG. 9, along with a listing of a leader's principal tasks during each of these stages.

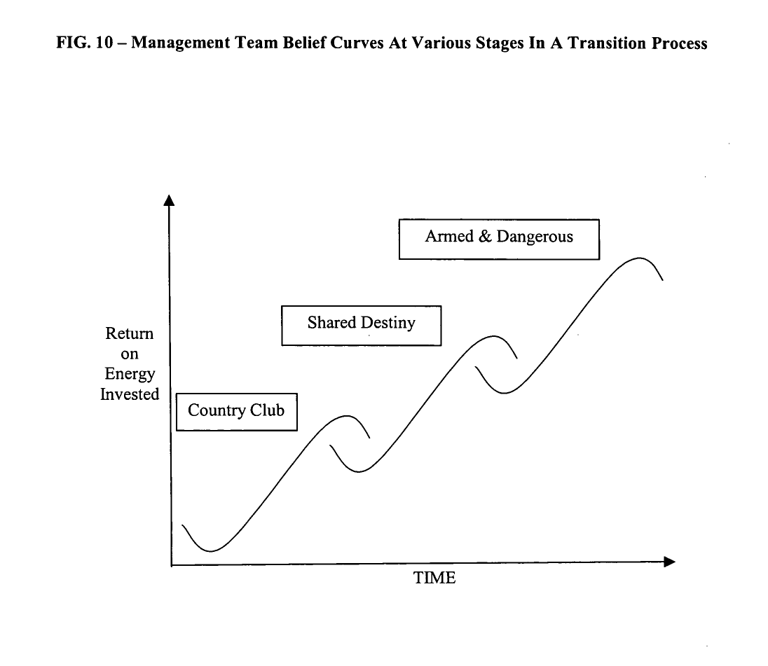

Management teams have been found to transition to new beliefs or higher levels of performance along a set of such belief curves in which each of these curves represents a different phase (i.e., country club, shared destiny, armed & dangerous) in the management team's transition process. This phenomena is illustrated in FIG. 10.

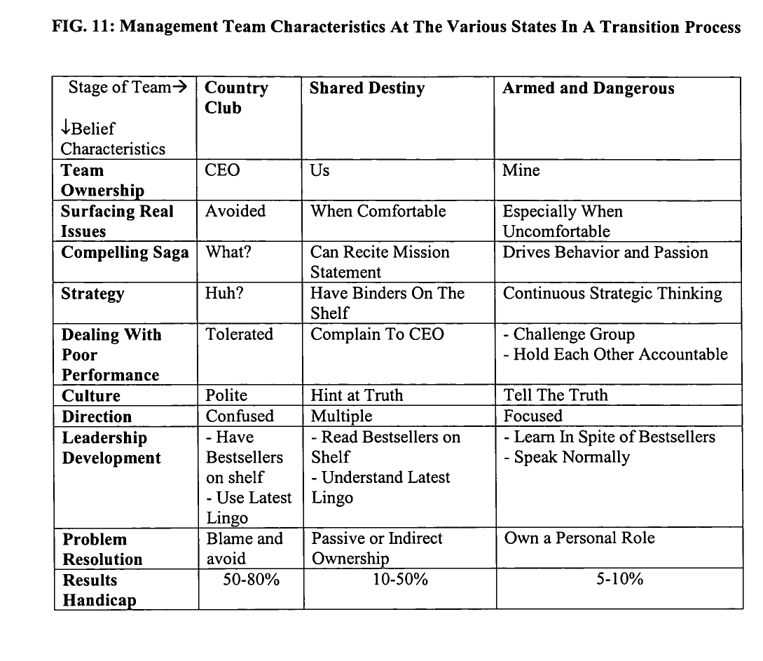

Organizations that are attempting to forsake old, ego-driven beliefs in favor of the adoption of new beliefs are also seem to demonstrate similar characteristics within their management teams. FIG. 11 illustrates the characteristics which I have often found to be evident in groups of organizational leaders at the various stages or phases along the path towards the adoption of new beliefs.

In summary, some of the most effective ways that I have discovered for leaders to mitigate the ego-driven, dysfunctional behavior of their employees include: (a) the use of despair or hopelessness to create an emptiness or void within which one exhibiting dysfunctional behavior can discover the courage to persevere and undergo the task of forsaking one's old beliefs and formulating new beliefs that allow one to adopt an authentic commitment to achieving desired organizational results, (b) the use of a compelling saga or passionate story in which one may believe and use to fill the voids in one's organizational life, (c) the creation of a feeling of shame in one exhibiting dysfunctional behavior as a means to promote the demise of one's ego-driven dysfunctional behavior, (d) the creation of aligned beliefs within an organization to change the experiential environment of an organization, (e) the education of employees that their perceptions of an organizational event is dependent upon their often ego-driven beliefs, (f) the establishment of a code of organizational behavior which gives employees a measure by which to hold those around them accountable for their actions, and (g) the use of symbols and rituals to align the beliefs of an organization.

The foregoing descriptions of the invention have been presented for purposes of illustration and description. Further, the description is not intended to limit the invention to the form disclosed herein. Consequently, variations and modifications commensurate with the above teachings, and combined with the skill or knowledge in the relevant art are within the scope of the present invention.

The preferred embodiments described herein are further intended to explain the best mode known of practicing the invention and to enable others skilled in the art to utilize the invention in various embodiments and with various modifications required by their particular applications or uses of the invention. It is intended that the appended claims be construed to include alternate embodiments to the extent permitted by the current art.

I claim:

1. A method for teaching leadership skills directed at obtaining desired organizational results to organizational leaders, said method comprising the steps of:
teaching that a barrier to achieving desired organizational results comes from the dysfunctional behavior of the ones that said leader is trying to lead,
teaching that said dysfunctional behavior is likely driven by said ones' beliefs, and
teaching that to remedy said dysfunctional behavior, a leader must alter the beliefs which underlie said dysfunctional behavior.

2. A method for teaching leadership skills as recited in claim 2, said method further comprising the steps of:
teaching that results do not occur only from content and process changes, but from behavior changes, and
teaching that one's behavior is driven by one's beliefs and that to alter said behavior one must alter said beliefs.

3. A method for teaching leadership skills as recited in claim 1, wherein a trait that characterize said dysfunctional behavior is cynicism, resistance to change, lack of commitment, lack of motivation, tendency to find blame, avoidance of accountability or lack of respect for leadership.

4. A method for teaching leadership skills as recited in claim 1, said method further comprising the step of:
teaching that one exhibiting said dysfunctional behavior has the dysfunctional belief that said behavior is not wrong.

5. A method for teaching leadership skills as recited in claim 2, said method further comprising the step of:
teaching that one exhibiting said dysfunctional behavior has the dysfunctional belief that said behavior is not wrong.

6. A method for teaching leadership skills as recited in claim 1, said method further comprising the steps of:
teaching that a source of said dysfunctional belief is one's ego,
teaching that said ego may allow one to place personal, selfish agendas ahead of actions or behavior that would be supportive of the attainment of said desired organizational results.

7. A method for teaching leadership skills as recited in claim 2, said method further comprising the steps of:
teaching that a source of said dysfunctional belief is one's ego,
teaching that said ego may allow one to place personal, selfish agendas ahead of actions or behavior that would be supportive of the attainment of said desired organizational results.

8. A method for teaching leadership skills as recited in claim 6, said method further comprising the steps of:
teaching leaders that diminishing the influence of the ego on one's beliefs can be accomplished by giving one something to belief in to such a degree that one will subordinate ego-influenced beliefs so as to support attainment of said desired organizational results; wherein this concept is referred to as the “death of ego-influenced beliefs,” teaching that a compelling, inspiring story can give one a higher cause and something to belief in to such a degree that one will subordinate ego-influenced beliefs, and
teaching that leaders are followed for the story they represent.

9. A method for teaching leadership skills as recited in claim 7, said method further comprising the steps of:
teaching leaders that diminishing the influence of the ego on one's beliefs can be accomplished by giving one something to belief in to such a degree that one will subordinate ego-influenced beliefs so as to support attainment of said desired organizational results; wherein this concept is referred to as the “death of ego-influenced beliefs,”
teaching that a compelling, inspiring story can give one a higher cause and something to belief in to such a degree that one will subordinate ego-influenced beliefs, and
teaching that leaders are followed for the story they represent.

10. A method for teaching leadership skills as recited in claim 1, said method further comprising the step of:
providing training in a method to mitigate one's dysfunctional beliefs and behavior,
wherein said mitigating method is chosen from the group of methods that utilize at least one of the following teaching techniques:
using despair or hopelessness to create an emptiness or void within which one exhibiting dysfunctional behavior can discover the courage to persevere and undergo the task of forsaking one's old beliefs so as to formulate new beliefs that allow one to adopt an authentic commitment to achieving desired organizational results,
educating one that one's interpretation of an organizational event is dependent upon one's ego-driven beliefs,
using a compelling saga or passionate story in which one may believe and use said saga to fill voids in one's organizational life,
creating a feeling of shame in one exhibiting dysfunctional behavior as a means to promote the demise of one's dysfunctional behavior,
developing of a code of organizational behavior which gives one a measure by which to hold those around them accountable for their actions, and
using symbols and rituals to align the beliefs of an organization.

11. A method for teaching leadership skills as recited in claim 2, said method further comprising the step of:
providing training in a method to mitigate one's dysfunctional beliefs and behavior,
wherein said mitigating method is chosen from the group of methods that utilize at least one of the following teaching techniques:
using despair or hopelessness to create an emptiness or void within which one exhibiting dysfunctional behavior can discover the courage to persevere and undergo the task of forsaking one's old beliefs so as to formulate new beliefs that allow one to adopt an authentic commitment to achieving desired organizational results,
educating one that one's interpretation of an organizational event is dependent upon one's ego-driven beliefs,
using a compelling saga or passionate story in which one may believe and use said saga to fill voids in one's organizational life,
creating a feeling of shame in one exhibiting dysfunctional behavior as a means to promote the demise of one's dysfunctional behavior,
developing of a code of organizational behavior which gives one a measure by which to hold those around them accountable for their actions, and
using symbols and rituals to align the beliefs of an organization.

12. A method for teaching leadership skills as recited in claim 6, said method further comprising the step of:
providing training in a method to mitigate one's dysfunctional beliefs and behavior,
wherein said mitigating method is chosen from the group of methods that utilize at least one of the following teaching techniques:
teaching that diminishing the influence of the ego on one's beliefs can be accomplished by giving one something to belief in to such a degree that one will subordinate ego-influenced beliefs so as to support attainment of said desired organizational results; wherein this concept is referred to as the “death of ego-influenced beliefs,”
teaching the creation of bravery by instituting a feeling of shame in one exhibiting dysfunctional behavior,
teaching the use of despair or hopelessness to create an emptiness or void within which one exhibiting dysfunctional behavior can discover the courage to persevere and undergo the task of forsaking one's old beliefs and formulating new beliefs that allow one to adopt an authentic commitment to achieving desired organizational results,
educating one that one's interpretation of an organizational event is dependent upon one's ego-driven beliefs,
using a compelling saga or passionate story in which one may believe and use said saga to fill voids in one's organizational life,
developing a code of honor or organizational behavior which gives one a measure by which to hold those around them accountable for their actions,
using symbols and rituals to align the beliefs of an organization, and
using sabotage training to ensure a no-excuse future in said organization.

13. A method for teaching leadership skills as recited in claim 7, said method further comprising the step of:
providing training in a method to mitigate one's dysfunctional beliefs and behavior,
wherein said mitigating method is chosen from the group of methods that utilize at least one of the following teaching techniques:
teaching that diminishing the influence of the ego on one's beliefs can be accomplished by giving one something to belief in to such a degree that one will subordinate ego-influenced beliefs so as to support attainment of said desired organizational results; wherein this concept is referred to as the “death of ego-influenced beliefs,”
teaching the creation of bravery by instituting a feeling of shame in one exhibiting dysfunctional behavior,
teaching the use of despair or hopelessness to create an emptiness or void within which one exhibiting dysfunctional behavior can discover the courage to persevere and undergo the task of forsaking one's old beliefs and formulating new beliefs that allow one to adopt an authentic commitment to achieving desired organizational results,
educating one that one's interpretation of an organizational event is dependent upon one's ego-driven beliefs,
using a compelling saga or passionate story in which one may believe and use said saga to fill voids in one's organizational life,
developing a code of honor or organizational behavior which gives one a measure by which to hold those around them accountable for their actions,
using symbols and rituals to align the beliefs of an organization, and using sabotage training to ensure a no-excuse future in said organization.
